(19) United States
(12) Patent Application Publication
(10) Pub. No.: US 2017/0191560 A1
(43) Pub. Date: Jul. 6, 2017

(54) Transmission Device

(71) Applicant: Daimler AG, Stuttgart (DE)

(72) Inventors: Stefan SPERRFECHTER, Donzdorf (DE); Heinrich STRAUB, Stuttgart (DE); Josep Maria BOU ROMANO, Stuttgart (DE); Tobias HAERTER, Stuttgart (DE); Peter HAHN, Stuttgart (DE); Jakub ROMANIAK, Stuttgart (DE); Juergen SCHWEITZER, Filderstadt (DE)

(73) Assignee: Daimler AG, Stuttgart (DE)

(21) Appl. No.: 15/312,954

(22) PCT Filed: May 22, 2015
(86) PCT No.: PCT/EP2015/001042

§ 371 Date: Nov. 21, 2016

(30) Foreign Application Priority Data
May 22, 2014 (DE) 10 2014 007 540.0

(51) Int. Cl. F16H 57/04; F16D 21/06; F16D 13/74

(52) U.S. Cl. CPC F16H 57/0423; F16D 13/74; F16D 21/06; F16H 57/045; F16H 57/0494; F16H 57/0473; F16D 13/385

(57) ABSTRACT

A dual clutch transmission device is disclosed. The dual clutch transmission device has a transmission device with a transmission housing, with a coupling housing positioned within the transmission housing and with a lubricant reservoir to receive a lubricant for the transmission device, which includes an oil trap ring connected at least indirectly with the transmission housing, which at least partially surrounds the coupling housing. The oil trap ring has a side facing the coupling housing which is primarily designed as an oil guide surface and which has at least one groove which is intended to guide lubricant into the lubricant reservoir. The dual clutch transmission device also has a gear set with a dry sump to lubricate the gear set.

### BACKGROUND AND SUMMARY OF THE INVENTION

The invention relates to a transmission device and a dual clutch transmission with a gear set, with a dry sump for lubricating the gear set and with a transmission device as per the invention.

A transmission device with a coupling housing, which restricts a coupling space to include at least one powershift clutch, and with a collection and guide plate for the selective forwarding of lubricating oil expelled from the coupling space is already known from DE 10 2005 059 115 A1.

From US 2008/128212 A1, a transmission device with a transmission housing, with a coupling housing positioned within the transmission housing and with a lubricant reservoir to receive a lubricant for the transmission device is known, whereby the lubricant reservoir comprises an oil trap ring connected at least indirectly with the transmission housing, which at least partially surrounds the coupling housing, whereby the oil trap ring comprises a side facing the coupling housing, which is primarily designed as an oil guide surface and which has at least one groove, which is intended to guide lubricant into the lubricant reservoir.

The invention is particularly based on the object to provide a transmission device, with which dry sump lubrication for the transmission device can be realized with minimum effort. A dry sump is understood to be a lubricant system for the transmission device as in the context of the invention, in which the sump of the transmission device, thus the lubricant sump of the transmission device is dry or a lubricant level in the lubricant sump is designed so that rotating transmission components are not immersed in the lubricant stored in the lubricant sump. Churning losses can be reduced with a dry sump.

The invention relates to a transmission device, in particular a dual clutch transmission device, with a coupling housing and with a lubricant reservoir for receiving a lubricant for the transmission device, which comprises an oil trap ring, which at least partially surrounds the coupling space.

Furthermore, the invention assumes that the oil trap ring comprises a side facing the coupling housing, which is primarily designed as an oil guide surface and which has at least one groove, which is intended to guide lubricant into the lubricant reservoir. In this context, the fact that the side facing the coupling housing “is designed as an oil guide surface” should be understood to mean that the side facing the coupling housing is intended to collect the lubricant expelled from the coupling housing and guide it to the lubricant reservoir. The oil guide surface is preferably free from projecting construction elements such as ridges. Specifically, the oil guide surface is intended to guide the lubricant to the minimum one groove for introduction in the lubricant reservoir. In this context, the fact that the side facing the coupling housing is “primarily” designed as an oil guide surface should be understood to mean that the minimum one groove accounts for maximum 8 percent, advantageously maximum 6 percent and preferably no more than 4 percent of a total surface of the side. “Surrounded” is particularly understood in context of the invention to mean that the oil trap ring surrounds the coupling space in the radial direction, whereby an annular space is formed between the coupling housing and the oil trap ring. In particular, the oil trap ring surrounds the coupling space at least partially in the axial direction. As the oil trap ring surrounds the coupling space at least partially in the axial direction, lubricant, which is centrifuged during operation of the transmission device from the lubricating points of the powershift clutch, is spun to the oil trap ring and guided from this into the lubricant reservoir, whereby a recirculation of lubricant from the lubricating points can be achieved back into the lubricant reservoir without use of a separate pump. Through such an embodiment, the dry sump can be realized with a low installation space requirement. By designing the side facing the coupling housing primarily as an oil guide surface, a smooth guide of the lubricant can also be achieved and foaming of the lubricant can be reduced. In addition, no additional conveyor devices are needed to guide the lubricant into the lubricant reservoir. There is also no need for additional control and/or regulating units to control and/or regulate the conveyor devices. Consequently, the dry sump can be realized with a reduced number of components and a reduced energy requirement and dry sump lubrication can be realized with little effort.

In particular, the oil trap ring is connected at least indirectly with a transmission housing of the transmission device. The oil trap ring is fixed at least indirectly to the transmission housing. The oil trap ring does not rotate around a rotation axis of the transmission device.

As per the invention, the dual clutch transmission comprises a gear set and a dry sump to lubricate the gear set. Lubrication of the gear set with low churning losses can be achieved with a low expenditure on equipment and reduced energy consumption by saving recirculating pumps.

Furthermore, it is suggested that the side of the oil trap ring facing the coupling housing comprises a slight radial interval to the coupling housing. In this context, “slight radial interval” should be understood to mean a radial interval which amounts to maximum 5 percent, advantageously maximum 4 percent and preferable no more than 3 percent of an external diameter of the coupling housing. The interval is a maximum of 15 mm irrespective of the external diameter of the coupling housing. As a result, rapid discharge of lubricant, which is centrifuged from the coupling housing during operation, can be achieved. The embodiment of an oil sump in the vicinity of a rotating operation of a coupling housing can be avoided as a result. Drag losses of the coupling due to rotation within an oil sump can be reduced as a result.

Furthermore, it is suggested that the interval is no more than 10 mm, preferably no more than 5 mm. As a result, particularly secure discharge of the lubricant, which is centrifuged from the coupling housing during operation, can be achieved.

Furthermore, it is suggested that the side facing the coupling housing forms at least a ramp to guide the lubricant. As a result, low-foaming introduction of the lubricant into the groove and therefore into the lubricant reservoir can be achieved. “Ramp” should specifically be understood as an area, in which the oil guide surface comprises a surface normal, which includes a pointed angle with a radial direction relating to a rotational axis of the transmission device.

Furthermore, it is suggested that the side facing the coupling housing of the oil trap ring has at least one further groove, which is staggered by an angle of no more than 150 degrees against the minimum one groove. As a result, efficient discharge of the lubricant impacting on the side of the oil trap ring facing the coupling housing and guided to the oil guide surface can be achieved. In particular, a high removal capacity can be achieved by the minimum one groove and the minimum one additional groove as well as a long guidance route to the oil guide surface to defoam the lubricant. An “angle of no more than 150 degrees” is understood specifically to be an angle relating to the rotational axis of the transmission device. Specifically, it is understood that the angle is oriented in one direction, along which the two grooves have a smallest interval to one another along the scale of the oil trap ring.

Furthermore, it is suggested that the oil trap ring has an upper half, in which the minimum two grooves are positioned. As a result, a long discharge route of the lubricant can be achieved from the grooves, which extends primarily from the upper half into the lower half of the oil trap ring. As a result, gas bubbles mixed into the lubricant can escape from the lubricant over time. As a result, a large separation of the lubricant from the admixed gas bubbles can be achieved. In this context, an “upper half” should be understood as a half of the oil trap ring, which is positioned on top relating to a direction of gravitational force after assembly in the transmission device. Preferably, all grooves are positioned in the upper half, irrespective of whether the oil trap ring only has one single groove or more grooves.

In one embodiment of the invention, the transmission housing and the oil trap ring restrict a partial volume of the lubricant reservoir at least in part. Specifically, the partial volume of the lubricant reservoir is restricted to at least one side by the transmission housing. Due to the fact that the partial volume of the lubricant reservoir according to this embodiment of the invention is restricted to at least one side by the transmission housing, a high heat transfer can be achieved through the transmission housing cooled with ambient air or even airstream and also generally furnished with ridges and the lubricant can be rapidly cooled. It is beneficial for the heat dissipation that the lubricant as per the invention does not just flow past a transmission housing restricting the partial volume as per this embodiment of the invention and impacts with the transmission housing in just brief contact, but that the lubricant is collected in the partial volume of the lubricant reservoir and thus remains in this for a greater period of time. As the oil trap ring connected at least indirectly with the transmission housing restricts the partial volume on a side facing the coupling housing, a saving of components and installation space can be achieved.

Furthermore, it is suggested that the oil trap ring forms an oil separator wall. As a result, efficient extraction of the centrifuged lubricant into the oil trap ring can be achieved. An “oil separator wall” should be understood as an introduction area for lubricant, which has an inclined wall, with which the oil separator wall engages in a mist of droplets of centrifuged lubricant, which has been spun off from the rotating powershift clutch, and which peels away a layer of lubricant from the mist, which is conveyed along the inclined wall in the oil trap ring. In particular, the oil separator wall has two edges, which comprise an offset from one another vertically to the peripheral direction and which engages in the mist of droplets of centrifuged lubricant.

Furthermore, it is suggested that the oil trap ring comprises lubricant lines, which are provided for internal shaft lubrication. As a result, it is possible to dispense with guide channels for lubricant in a transmission housing and a transmission housing with increased stability can be achieved. An “internal shaft lubrication” is to be understood specifically as a supply of lubricant to a shaft, wherein the lubricant is introduced via channels positioned within a shaft and passes via outlet channels to an outer side of the shaft to lubricating points.

In one embodiment of the invention, the lubricant reservoir comprises a transmission chamber, in which a partial volume of the lubricant can be stored, whereby an electrohydraulic control unit is positioned within the transmission chamber.

Furthermore, it is suggested that the partial volume, which is formed using the oil trap ring, has a partial volume of at least 0.4 liters, preferably at least 0.6 liters and particularly preferred at least 0.8 liters.

Furthermore, it is suggested that the partial volume of the lubricant reservoir, which is formed using the oil trap ring, and the partial volume of the lubricant reservoir, which is formed by the transmission chamber, have together a reservoir volume of at least 2 liters, preferably at least 2.5 liters and particularly preferred at least 3 liters.

Furthermore, it is suggested that the oil trap ring is designed as a storage ring, whereby the lubricant reservoir comprises a transmission chamber, in which a partial volume of the lubricant can be stored, which is less than a partial volume that can be stored in the oil trap ring designed as a storage ring. A settling chamber can be provided by the transmission chamber, in which the centrifuged lubricant, which has been conveyed by the oil trap ring, can settle and gas bubbles that are mixed in the centrifuged lubricant can escape from the lubricant without a total volume of the transmission device being increased unnecessarily. From “the partial volume of the lubricant that can be stored in the transmission chamber is less than a partial volume that can be stored in the oil trap ring designed as a storage ring”, it should be specifically understood in this context that a partial volume of the lubricant can be stored in the transmission chamber, which comprises a maximum 70 percent, advantageously a maximum of 50 percent and preferably not more than 40 percent of a partial volume, which can be stored in the oil trap ring designed as a storage ring.

Further advantages result from the following description of the figures. In the figures, three embodiments of the invention are shown. The figures, the description of the figures and the claims contain numerous features in combination. The person skilled in the art will also expediently consider the features individually and combine them into further, meaningful combinations.

### BRIEF DESCRIPTION OF THE DRAWINGS

FIG. 1 a schematic representation of a dual clutch transmission with a gear set, with a dry sump for lubricating the gear set and with a transmission device,

FIG. 2 a representation of the transmission device with an oil trap ring partially surrounding a coupling housing in the axial direction,

FIG. 3 a detailed representation of the oil trap ring of the transmission device,

FIG. 4 a sectional top view of the oil trap ring,

FIG. 5 a sectional bottom view of the oil trap ring,

FIG. 6 a view of an alternative embodiment of the oil trap ring,

FIG. 7 a view of another alternative embodiment of the transmission device,

FIG. 8 a detailed representation of the oil trap ring, and

FIG. 9 a sectional view of the transmission device.

### DETAILED DESCRIPTION OF THE DRAWINGS

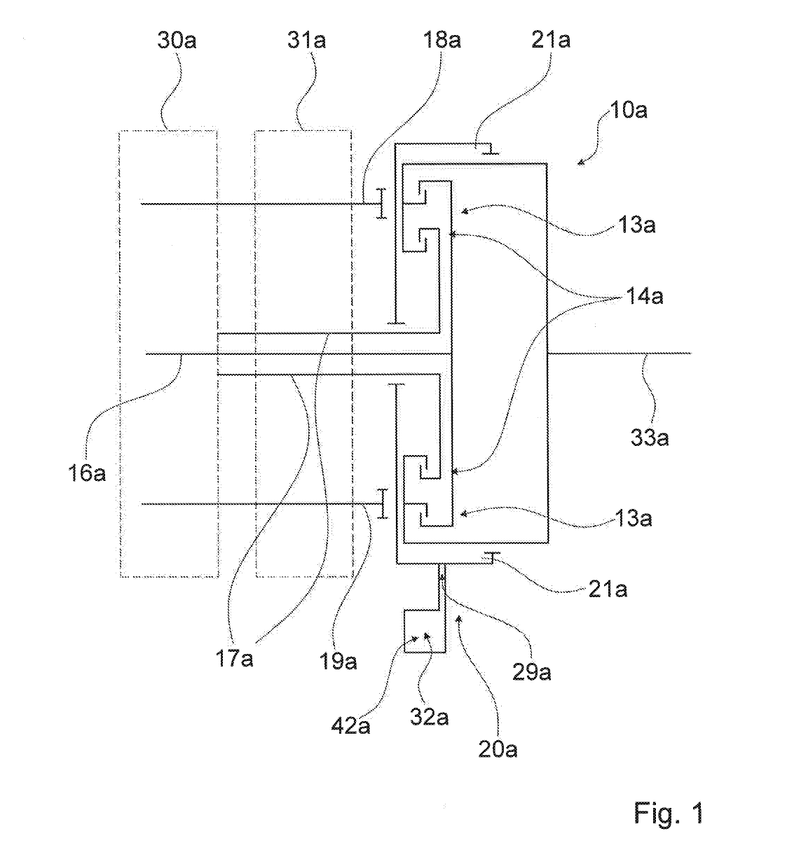

FIG. 1 shows a schematic representation of a dual clutch transmission with a gear set, with a dry sump for lubricating the gear set and with a transmission device 10a. The dual clutch transmission comprises two partial gears 30a, 31a for the even gears or the odd gears. The dual clutch transmission also comprises a hollow shaft 17a with an inner shaft 16a accommodated therein, an upper output shaft 18a and a lower output shaft 19a. The hollow shaft 17a forms an input shaft for the first partial gear 30a, and the inner shaft 16a forms an input shaft for the second partial gear 31a. Furthermore, the dual clutch transmission comprises a main input shaft 33a, which is connected with a crank shaft of an engine.

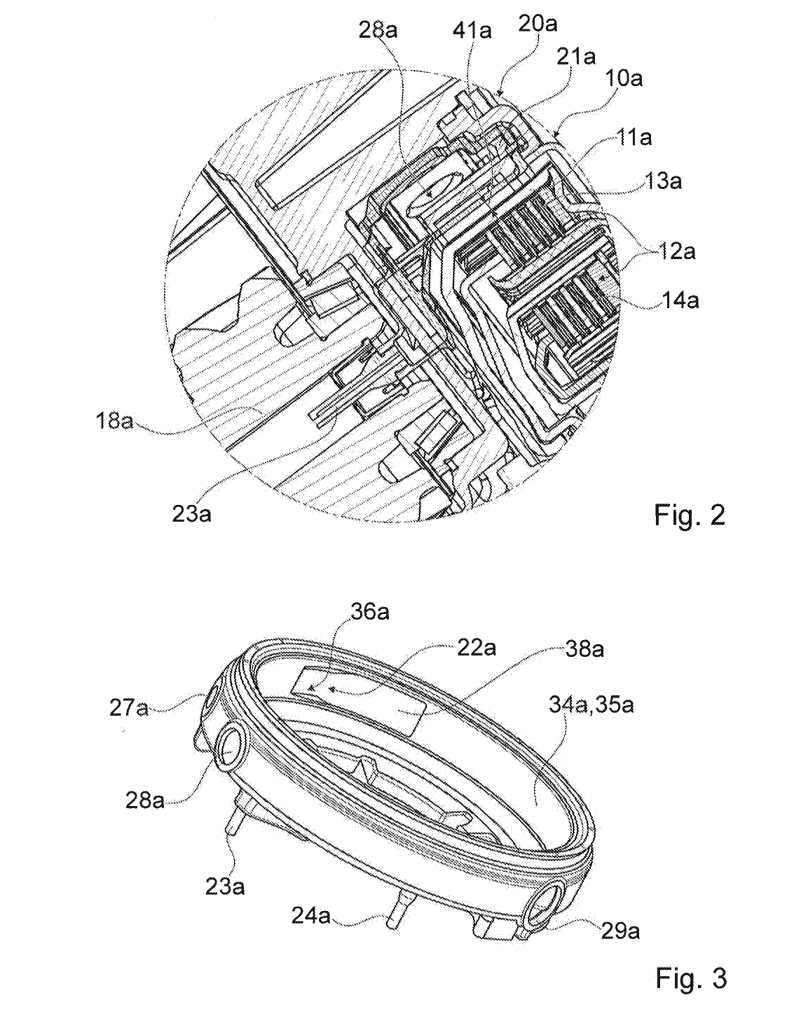

The transmission device 10a comprises a coupling housing 11a, which restricts a coupling space 12a for receiving a powershift clutch 13a, and a lubricant reservoir 20a to receive a lubricant for the transmission device 10a (FIG. 2). The coupling housing 11a comprises two powershift clutches 13a, 14a, which are designed as multi-plate couplings. By closing one of the powershift clutches 13a, 14a and opening the other powershift clutch 13a, 14a, it is possible to switch between two different gears. In the depicted embodiment, the coupling housing 11a forms an external plate support of the external powershift clutch 13a. However, it is also conceivable that the coupling housing 11a and the external plate support are formed separately from one another, whereby in such an embodiment the coupling housing 11a is connected with a rotating component of one of the powershift clutches 13a, 14a.

The upper output shaft 18a and the lower output shaft 19a, bearing for supporting the shafts, gear wheels of the gear set and the powershift clutches 13a, 14a are lubricated and cooled with lubricant, which is stored in the lubricant reservoir 20a. The lubricant consists of lubricating oil. During an operation, in which the powershift clutch 13a is switched under load, the upper output shaft 18a, the lower output shaft 19a and the powershift clutches 13a, 14a rotate. Lubricant, which lubricates the shafts and the powershift clutches 13a, 14a, is centrifuged by this rotation.

The lubricant reservoir 20a comprises an oil trap ring 21a, which partially surrounds the coupling space 12a in the axial direction. The oil trap ring 21a surrounds the coupling housing 11a. The oil trap ring 21a is designed as a storage ring. The oil trap ring 21a being designed as a storage ring forms an annular body, in which lubricant channels 26a and a surrounding annular channel 25a are formed in an interior of the body, which are formed separately from one another (FIG. 5). The lubricant reservoir 20a comprises a total volume for storing operating material. The lubricant channels 26a and the surrounding annular channel 25a form two partial volumes 42′a, 42″a of the total volume. The oil trap ring 21a being designed as a storage ring to store lubricant comprises a storage capacity of 0.8 liters of lubricant.

The oil trap ring 21a comprises a side 34a facing the coupling housing 11a, which is formed primarily as an oil guide surface 35a. The side 34a facing the coupling housing 11a comprises a groove 36a, which is intended to guide lubricant into the lubricant reservoir 20a. The lubricant impacting on the oil guide surface 35a having centrifuged from the coupling housing 11a during operation is guided to the groove 36a along the oil guide surface 35a. The oil guide surface 35a is formed primarily smoothly, so that lubricant guided along the oil guide surface 35a is guided in a less turbulent, smooth flow. Admixed air bubbles can escape from the lubricant guided smoothly along the oil guide surface 35a. The lubricant is therefore defoamed.

The side 34a facing the coupling housing 11a comprises a slight radial interval 41a to the coupling housing 11a. The interval 41a between the coupling housing 11a and the oil guide surface 35a is 6.0 mm±2.0 mm. The oil guide surface 35a is designed in the shape of a cylinder barrel surface with constant radius of curvature. The interval 41a between the side 34a of the oil trap ring 21a facing the coupling housing 11a and the coupling housing 11a is constant at least in a partial area in the depicted embodiment, in which the coupling housing 11a comprises a primarily smooth surface.

In the oil trap ring 21a, a total of three openings are formed: a filling opening 27a, through which a lubricant reserve is filled and thus inserted into the gears, a return port 28a, through which lubricant is guided from a wheelset chamber back to the lubricant reservoir 20a, and an output port 29a, which forwards the lubricant (FIG. 3). The filling opening 27a is intended for initial filling and for further fillings of the lubricant reservoir 20a and is closed with a stopper after filling the lubricant reservoir 20a. The filling opening 27a is connected with the circumferential annular channel 25a.

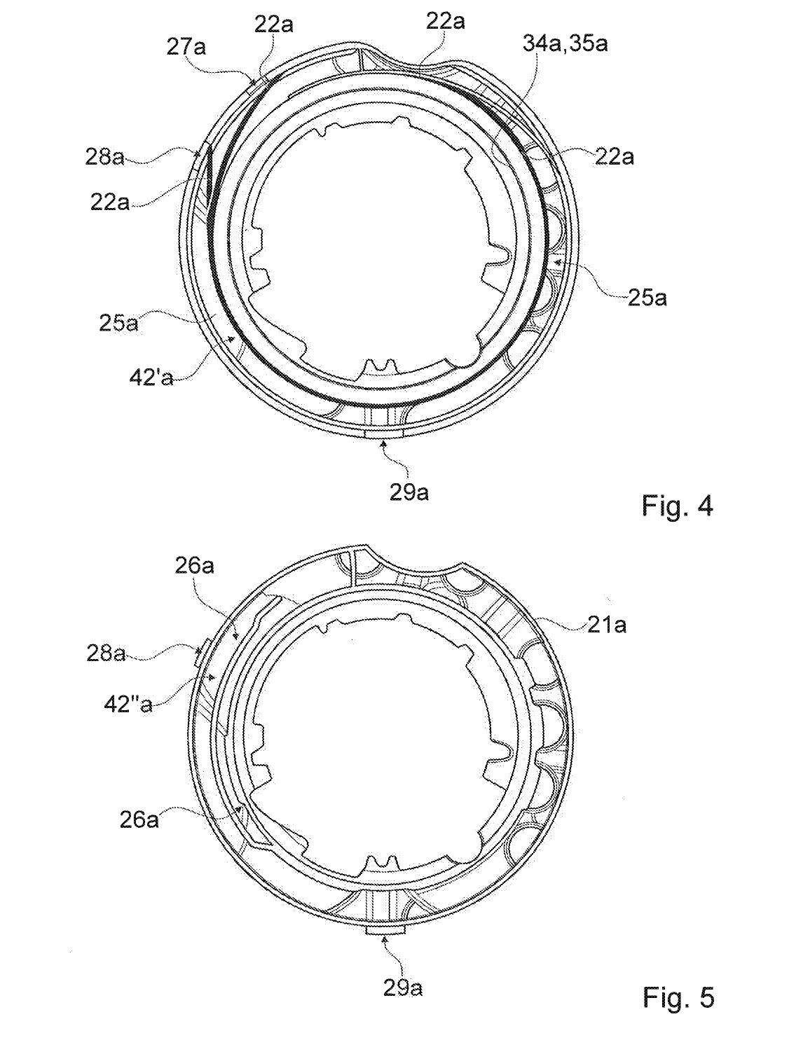

The side 34a of the oil trap ring 21a facing the coupling housing 11a forms a ramp 38a in a partial area to guide the lubricant. In the partial area, in which the side 34a forms the ramp 38a, the interval 41a between the side 34a and the coupling housing 11a successively increases along a peripheral direction. The groove 36a directly borders the ramp 38a. The oil trap ring 21a forms an oil separator wall 22a on the side 34a facing the coupling housing 11a, which is formed by inclined wall areas, which form the ramp 38a (FIG. 4). The oil separator wall 22a is formed by the ramp 38a and the groove 36a adjoining the ramp 38a. The oil separator wall 22a conveys lubricant being centrifuged by a rotating operation of the coupling housing 11a and impacting on an inner side of the oil trap ring 21a into the circumferential annular channel 25a, from where it flows to the output port 29a. The oil trap ring 21a is fitted with an inclined position to a direction of the gravitational force so that the lubricant flows to the output port 29a through the effect of gravitational force.

An undepicted differential gear of the dual clutch transmission conveys through its rotation during operation of the dual clutch transmission the lubricant from a wheelset chamber, in which the gears are positioned, into the oil trap ring 21a formed as a storage ring. The oil trap ring 21a is positioned so that the lubricant conveyed by the differential gear impacts on the return port 28a and enters the circumferential annular channel 25a from there. The oil trap ring 21a is positioned with an inclined position against a direction of the gravitational force so that the lubricant in the circumferential annular channel 25a flows to the output port 29a. The dry sump is realized by conveying the lubricant away from the wheelset chamber.

The dual clutch transmission comprises furthermore an electrohydraulic control unit, which controls the powershift clutch 13a. The electrohydraulic control unit is positioned within a transmission chamber 32a of the dual clutch transmission. The transmission chamber 32a forms a further partial volume 42a of the lubricant reservoir 20a. A partial volume of the lubricant encircled by the transmission chamber 32a is greater than a partial volume of the lubricant encircled by the oil trap ring 21a (FIG. 1). The transmission chamber 32a is connected with the oil trap ring 21a through the output port 29a. The partial volume of the lubricant encircled by the transmission chamber 32a is 2.8 liters and is thus greater than that of the stored partial volume of 0.8 liters of lubricant of the partial volumes 42′a, 42″a of the lubricant reservoir 20a, which is encircled by the oil trap ring 21a. The transmission chamber 32a forms a further partial volume 42a of the lubricant reservoir 20a. Thus in the lubricant reservoir 20a, a total volume of 3.6 liters of lubricant is stored in the depicted embodiment. Thus in the oil trap ring 21a, a partial volume of the lubricant is stored, which is less than a third of the partial volume stored in the transmission chamber 32a.

Lubricant, which has been conveyed into the oil trap ring 21a, flows into the transmission chamber 32a after passing through the oil trap ring 21a. In the transmission chamber 32a, the lubricant is stored for a defined period of time before being sucked by a suction filter. During this time, the foamed lubricating oil calms and any arising gas bubbles separate from the lubricant. A lubricant, which is received by the oil separator wall 22a, is already at least partially defoamed by said oil separator wall and by a retention period in the oil trap ring 21a.

The oil trap ring 21a comprises lubricant lines 23a, 24a, which are provided for internal shaft lubrication (FIG. 2). The lubricant line 23a is provided for internal shaft lubrication of the upper output shaft 18a and the lubricant line 24a is provided for internal shaft lubrication of the lower output shaft 19a. The lubricant lines 23a, 24a are formed as projecting tubes, which engage into an inner area of the upper output shaft 18a or the lower output shaft 19a and guide lubricant to these. The lubricant lines 23a, 24a are connected with the lubricant channels 26a, in which the lubricant is stored.

A suction filter is also positioned in the transmission chamber 32a, with which the lubricant is sucked. The transmission chamber 32a is connected with the oil trap ring 21a using a corresponding tube. The lubricant is conveyed into the corresponding tube via the suction filter and the lubricant flows from there further into the lubricant channels 26a, from where it is conveyed via lubricant lines 23a, 24a into an inner part of the upper output shaft 18a and the lower output shaft 19a for internal shaft lubrication.

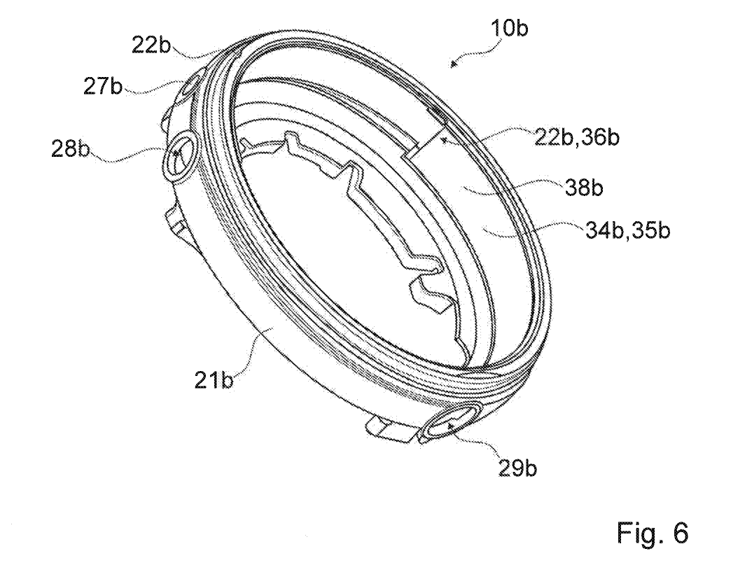

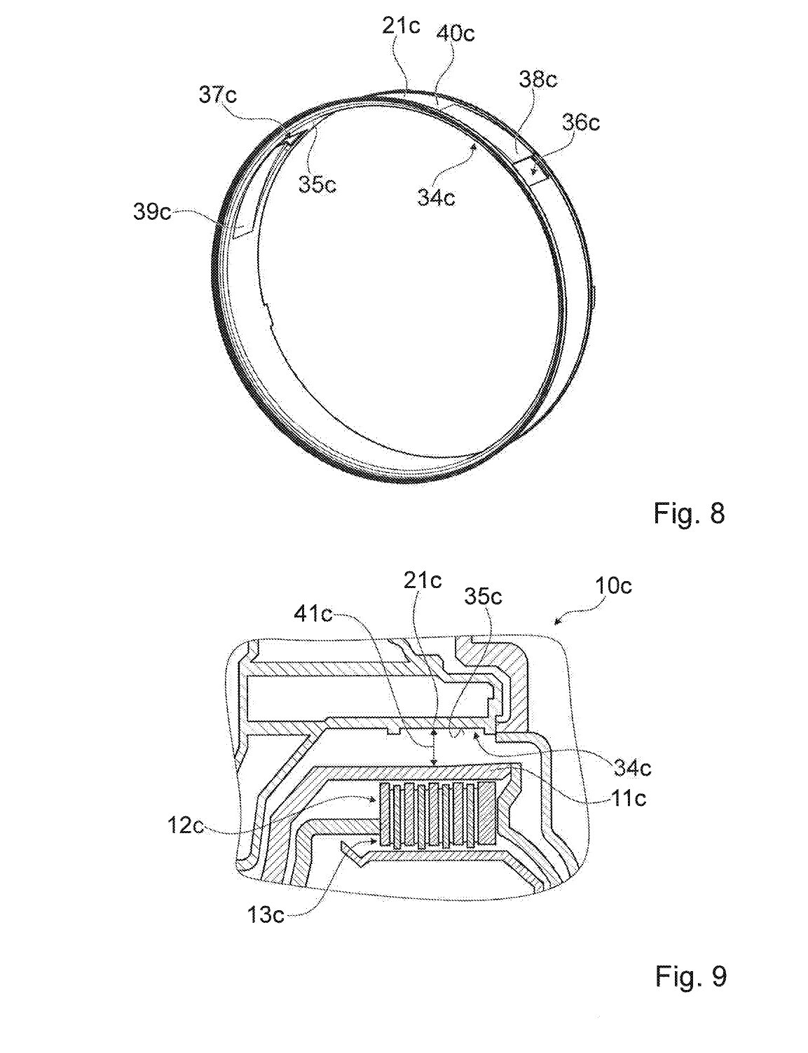

Two further embodiments of the invention are shown in FIGS. 6 to 9. The following description is primarily restricted to the differences between the embodiments, whereby reference can also be made to the figures and/or description of the other embodiments, specifically the embodiment in FIGS. 1 to 5, regarding equally designated components, particularly with respect to components with the same reference numerals. To differentiate between the embodiments, the letter a is replaced in the reference numerals of the embodiment in FIGS. 1 to 5 by the letters b and c in the reference numerals of the embodiments of FIGS. 6 to 9.

Another embodiment of a transmission device as per the invention 10b comprises an alternative embodiment of an oil trap ring 21b of a lubricant reservoir 20b. The oil trap ring 21b comprises a side 34b facing the coupling housing, which is formed primarily as an oil guide surface 35b. The side 34b facing the coupling housing comprises a groove 36b, which is intended to guide lubricant into the lubricant reservoir 20b. The side 34b of the oil trap ring 21b facing the coupling housing 11b forms a ramp 38b in a partial area to guide the lubricant. In the partial area, in which the side 34a forms the ramp 38b, the interval 41b between the side 34b and the coupling housing 11b successively increases along a peripheral direction. The groove 36b directly borders the ramp 38b. The oil trap ring 21b forms an oil separator wall 22b on the side 34b facing the coupling housing 11b, which is formed by inclined wall areas, which form the ramp 38b. The oil separator wall 22b is formed by the ramp 38b and the groove 36b adjoining the ramp 38b. The oil trap ring 21b is only intended in this embodiment to convey lubricant impacting on the side 34b facing the coupling housing into a circumferential annular channel 25b using the oil separator wall 22b. From there, the lubricant is forwarded via an output port 29b as in the preceding embodiment. Lubrication of the shafts is then effected via channel structures into a transmission housing.

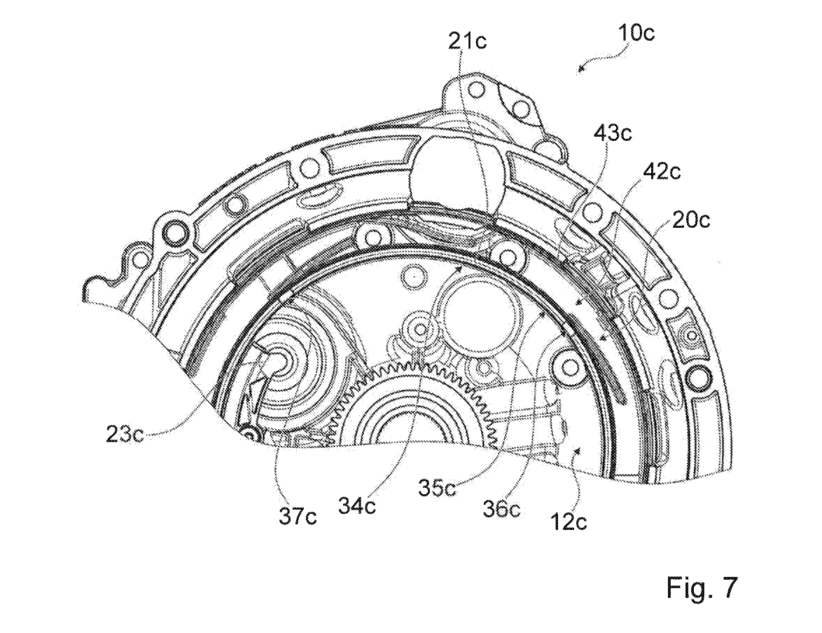

FIGS. 7 to 9 show another alternative embodiment of a transmission device 10c designed as a dual clutch transmission device. The transmission device 10c comprises a transmission housing 43c, a coupling housing 11c positioned within the transmission housing 43c and a lubricant reservoir 20c to receive a lubricant for the transmission device 10c. The lubricant reservoir 20c comprises an oil trap ring 21c connected indirectly with the transmission housing 43c, which at least partially surrounds the coupling housing 11c. The oil trap ring 21c is designed as a metal ring and comprises a diameter of 237 mm and a width of 50 mm.

The oil trap ring 21c comprises a side 34c facing the coupling housing 11c, which is formed primarily as an oil guide surface 35c. The side 34c facing the coupling housing 11c comprises a groove 36c, which is intended to guide lubricant into the lubricant reservoir 20c. The lubricant impacting on the oil guide surface 35c having centrifuged from the coupling housing 11c during operation is guided to the groove 36c along the oil guide surface 35c. The oil guide surface 35c is formed primarily smoothly, so that lubricant guided along the oil guide surface 35c is guided in a less turbulent, smooth flow. Admixed air bubbles can escape from the lubricant guided smoothly along the oil guide surface 35c. The lubricant is therefore defoamed. External dimensions of the groove 36c are 16 mm and 32 mm. The groove 36c has a rectangular shape. In alternative embodiments, the groove 36c can have different shapes and comprise different dimensions. A front side of the groove 36a runs primarily vertically to a surface normal of the oil guide surface 35a, so that the lubricant flows into the lubricant reservoir 20c on the groove 36c at an approximate tangent to the oil guide surface 35c.

The side 34c facing the coupling housing 11c comprises a slight radial interval 41c to the coupling housing 11c. The interval 41c is 5 mm. The coupling housing 11c has a diameter of 227 mm. The interval 41c thus amounts to 2.2 percent of the diameter of the coupling housing 11c.

The side 34c of the oil trap ring 21c facing the coupling housing 11c forms a ramp 38c to guide the lubricant. The ramp 38c is designed as an area being recessed away from the direction of the coupling housing 11c of the side 34c facing the coupling housing 11c. The ramp 38c adjoins the groove 36c. When viewed in the peripheral direction of the side 34c facing the coupling housing 11c, the ramp 38c is designed as a lowered area relating to the oil guide surface 35c. The ramp 38c extends over an angle range of 50 degrees in the peripheral direction of the side 34c of the oil trap ring 21c facing the coupling housing 11c of the oil trap ring 21c. The ramp 38c comprises a gradually increasing depth, which comprises its greatest expansion directly at the groove 36c. Lubricant running along the oil guide surface 35c is conveyed to the groove 36c by the ramp 38c.

The side 34c of the oil trap ring 21c facing the coupling housing 11c comprises a further groove 37c, which is staggered by an angle of 90 degrees against the first groove 36c. The angle of 90 degrees is measured in the direction along a scale of the oil trap ring 21c, along which the two grooves 36c, 37c comprise a smallest interval to one another. In alternative embodiments of the oil trap ring 21c, the further groove 37c and the first groove 36c can be staggered by a different angle than 90 degrees, for example in an angle between 90 degrees and 150 degrees or a lesser angle than 90 degrees. The further groove 37c is designed identically to the groove 36c. The side 34c facing the coupling housing 11c forms a further ramp 39c which is designed identically to the ramp 38c. The further ramp 39c guides lubricant to the further groove 37c. It is conceivable that the side 34c facing the coupling housing 11c in alternative embodiments comprises a third groove or two further grooves, which are positioned between the first groove 36c and the further groove 37c.

The oil trap ring 21c comprises an upper half 40c, in which the two groove 36c, 37c are positioned. The upper half 40c is positioned on top relating to a direction of gravitational force after assembly in the transmission device 10c. With an embodiment of the oil trap ring 21c with just one groove 36c, this is also positioned in the upper half 40c.

The transmission housing 43c and the oil trap ring 21c partially restrict a partial volume 42c of the lubricant reservoir 20c. After entering through the grooves 36c, 37c, the lubricant flows downwards in the direction of gravitational force along a side 34c of the oil trap ring 21c facing away from coupling housing 11c and is stored in the partial volume 42c. A largest part of a stored volume of the lubricant is stored in an area of a lower half of the oil trap ring 21c in the partial volume 42c. Between the oil trap ring 21c and the transmission housing 43c, an unelaborated cured-on seal ring is positioned to seal the partial volume 42c. The transmission housing 43c is metallic and conducts a thermal energy of the lubricant.

### LIST OF REFERENCE NUMERALS

10 Transmission device

11 Coupling housing

12 Coupling space

13 Powershift clutch

14 Powershift clutch

16 Inner shaft

17 Hollow shaft

18 Upper output shaft

19 Lower output shaft

20 Lubricant reservoir

21 Oil trap ring

22 Oil separator wall

23 Lubricant line

24 Lubricant line

25 Annular channel

26 Lubricant channel

27 Filling opening

28 Return port

29 Output port

30 Partial gear

31 Partial gear

32 Transmission chamber

33 Main input shaft

34 Side

35 Oil guide surface

36 Groove

37 Groove

38 Ramp

39 Ramp

40 Half

41 Interval

42 Partial volume

43 Transmission housing

1.-11. (canceled)

12. A dual clutch transmission device, comprising:
a transmission device, wherein the transmission device includes:
a transmission housing;
a coupling housing disposed within the transmission housing; and
a lubricant reservoir, wherein the lubricant reservoir receives a lubricant for the transmission device and wherein the lubricant reservoir includes an oil trap ring which is connected at least indirectly with the transmission housing and which at least partially surrounds the coupling housing;
wherein the oil trap ring includes a side that faces the coupling housing, wherein the side facing the coupling housing is primarily designed as an oil guide surface and has a first groove, wherein the first groove guides the lubricant into the lubricant reservoir; and
a gear set with a dry sump to lubricate the gear set.

13. The dual clutch transmission device according to claim 12, wherein the side of the oil trap ring is disposed at a slight radial interval from the coupling housing.

14. The dual clutch transmission device according to claim 13, wherein the slight radial interval is a maximum of 10 mm.

15. The dual clutch transmission device according to claim 12, wherein the side of the oil trap ring has a ramp, and wherein the lubricant is guidable by the ramp.

16. The dual clutch transmission device according to claim 12, wherein the side of the oil trap ring has a second groove which is staggered by an angle of no more 150 degrees against the first groove.

17. The dual clutch transmission device according to claim 16, wherein the oil trap ring includes an upper half, wherein the first groove and the second groove are disposed in the upper half.

18. The dual clutch transmission device according to claim 12, wherein the transmission housing and the oil trap ring at least partially restrict a partial volume of the lubricant reservoir.

19. The dual clutch transmission device according to claim 12, wherein the oil trap ring forms an oil separator wall.

20. The dual clutch transmission device according to claim 12, wherein the lubricant reservoir includes a transmission chamber in which a partial volume of the lubricant is storable and wherein an electrohydraulic control unit is disposed within the transmission chamber.

21. The dual clutch transmission device according to claim 12, wherein a partial volume of the lubricant reservoir which is formed using the oil trap ring is at least 0.4 liters.
